(19) United States
(12) Patent Application Publication
(10) Pub. No.: US 2014/0181985 A1
(43) Pub. Date: Jun. 26, 2014

(54) Content Specific Data Scrambling

(71) Applicant: BROADCOM CORPORATION, Irvine, CA (US)

(72) Inventors: Rajesh Shankarrao Mamidwar, San Diego, CA (US); Francis Cheung, Del Mar, CA (US)

(73) Assignee: Broadcom Corporation, Irvine, CA (US)

(21) Appl. No.: 13/724,435

(22) Filed: Dec. 21, 2012

(51) Int. Cl. G06F 21/64

(52) U.S. Cl. CPC G06F 21/64
USPC 726/26

(57) ABSTRACT

An electronic device may include multiple modules that share access to a common memory. The electronic device may include content access logic that selective allows a module to access target data in the memory. When writing data into the memory, the content access logic may determine an access restriction associated with the write data, where the access restriction specifies one or more modules that can access the write data. The content access logic may scramble the write date using an access key, and configure the access key such that only authorized modules can use the access key when retrieving data from the memory. The content access logic may then store the scrambled data in the memory.

### TECHNICAL FIELD

This disclosure relates to storing data in memory. In particular, this disclosure relates to storing content specific scrambled data in memory.

### BACKGROUND

With the rapid advance of technology in the past decades, complex electronic devices are in widespread use in virtually every context of day to day life. Electronic devices may often be quite simple, but often have hundreds or thousands of individual electronic elements that are needed to implement the device. The electronic elements, e.g., modules, may share a common memory. Software frequently interfaces with the electronic components and improvements in security measures for such devices will help continue to drive the widespread adoption and demand for such devices.

### BRIEF DESCRIPTION OF THE DRAWINGS

The innovation may be better understood with reference to the following drawings and description. In the figures, like reference numerals designate corresponding parts throughout the different views.

FIG. 1 shows an example of an electronic device 100 that employs content specific data scrambling.

FIG. 2 shows an example of a system that employs content specific data scrambling.

FIG. 3 shows an example of a logic that the electronic device may implement as hardware, software, or both.

FIG. 4 shows an example of a system that employs content specific data scrambling.

FIG. 5 shows an example of a system that employs content specific data scrambling.

FIG. 6 shows an example of logic that the electronic device may implement as hardware, software, or both.

FIG. 7 shows an example of a system that employs content specific data scrambling.

### DETAILED DESCRIPTION

The discussion below refers to systems, devices, logic, circuitry, and methods that may be employed to control access to content stored in a shared memory. As described in greater detail below, content access logic, e.g., a memory controller, may scramble data to be stored in a memory using a determined access key. The term “scramble” or “scrambling” may refer to any processing performed by the content access logic on data to be stored in the memory in order to control access to the data. Examples of scrambling techniques the content access logic may employ include data encrypting, transposing, inverting, randomizing, encoding, securing, or any other form of processing the control access logic may apply to the data to make the data unintelligible without corresponding descrambling logic and/or a descrambling key, e.g., an access key. The discussion below may also refer to “encrypted” data, which may result from a separate data encryption process performed by systems and/or logic other than the content access logic. For example, encrypted data may have been produced by a security module, an audio/video content provider, a security processor, a digital rights management (DRM) system, or any other logic external to the content access logic. In some instances, the scrambling performed by the content access logic may share, at least in part, common encryption schemes, techniques, processing steps, etc. as performed by other modules, systems, and logic external to the content access logic. That is, the content access logic may encrypt data as part of the scrambling processing when controlling access to data in a memory, but may perform additional or alternative processing as part of the data scrambling as well.

The content access logic may select a particular access key to scramble and/or descramble data based on predetermined modules that can or cannot access the data. When a module requests to read the data stored in the memory, the content access logic may request an access key associated with the memory read and uses the received key to descramble the data from the memory. Accordingly, the content access logic may efficiently control access to data stored in the shared memory, as described below.

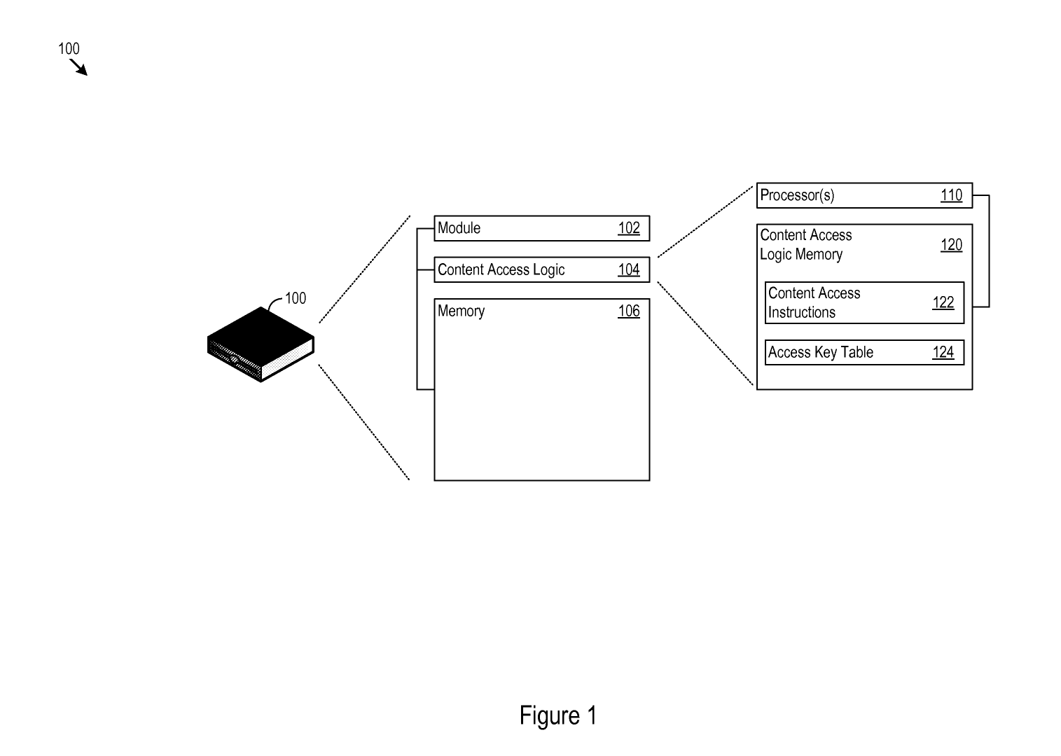

FIG. 1 shows an example of an electronic device 100 that employs content specific data scrambling. The electronic device 100 may be any device that receives, processes, or stores data. As examples, the electronic device 100 may be a laptop, desktop, or other type of computer, a personal data assistant, or a portable email device. Additional examples of electronic devices include televisions, stereo equipment such as amplifiers, pre-amplifiers, and tuners, set-top-boxes, mobile telephones, tablet devices, home media devices such as compact disc (CD)/digital versatile disc (DVD) players, portable MP3 players, high definition (e.g., Blu-Ray™ or DVD audio) media players, home media servers, or multi-user servers shared by multiple users and/or applications. Other examples of electronic devices include vehicles such as cars and planes, societal infrastructure such as power plants, traffic monitoring and control systems, or radio and television broadcasting systems. Further examples include home climate control systems, washing machines, refrigerators and freezers, dishwashers, intrusion alarms, audio/video surveillance or security equipment, network attached storage, and network routers and gateways. The electronic devices may be found in virtually any context, including the home, business, public spaces, or automobile. Thus, as additional examples, the electronic devices may further include automobile engine controllers, audio head ends or DVD players, satellite music transceivers, noise cancellation systems, voice recognition systems, climate control systems, navigation systems, alarm systems, or other devices.

In FIG. 1, the electronic device 100 includes a module 102, content access logic 104, and a memory 106. The module 102 may be any physical or logical module in the electronic device 100, and vary widely in form, function, and complexity. The module 102 may perform any number of processing or functions, and, in that regard, may retrieve, process, or store data to or from the memory 106. As illustrative examples, in the context of a computer system, the module 102 may include input/output interfaces (e.g., Universal Serial Bus (USB) interfaces), processing units such as a Central Processing Unit (CPU), Graphics Processing unit (GPU), or Security Processor, clock or timing logic, decoding units, network interfaces, communication modules or interfaces, audio/video processing units, firmware ROMs (e.g., a basic input/output system (BIOS) ROM), security logic, and countless other types of modules. The module 102 may be one of multiple modules in a system-on-a-chip (SoC) sharing a common memory.

The electronic device 100 shown in FIG. 1 may include multiple modules, e.g., the module 102, that share a common memory such as the memory 106. The modules may retrieve and/or store data in the memory. The memory 106 may take several forms, including as a random access memory (RAM) whether static or dynamic, CPU registers, external hard drive, flash memory, caches (e.g., L1, L2, or L3 cache), virtual memory, swap spaces, or others. In one implementation, the memory 106 does not include any physical or logical partitions of addresses in the memory space of the memory 106. Accordingly, the module 102, for example, may configure any space in the memory 106 for a particular purpose, e.g., as a decode buffer. Moreover, when the memory 106 is not physically or logically partitioned, any of the modules sharing use of the memory 106 could potentially access, e.g., read, data stored at any memory address in the memory 106.

As described in greater detail below, the content access logic 104 may control access to data in memory 106 according to any combination of the data content, data type, data priority, requesting module, or other factors. For example, the content access logic 104 may be implemented as part of a memory controller. In one implementation, the content access logic 104 includes one or more processors 110, including, for example, a security processor. The processors 110 may be communicatively linked to a content access logic memory 120. The content access logic memory 120 may be implemented as a dedicated memory associated with the content access logic 104 or, alternatively, as part of an external and/or shared memory. The content access logic memory 120 stores, for example, content access instructions 122 and an access key table 124. The content access logic 104 may control access to the memory 106 using access keys stored in the access key table 124. In that regard, entries in the access key table 124 may associate an access key with one or more modules, including with respect to memory read operations, memory write operations, or both.

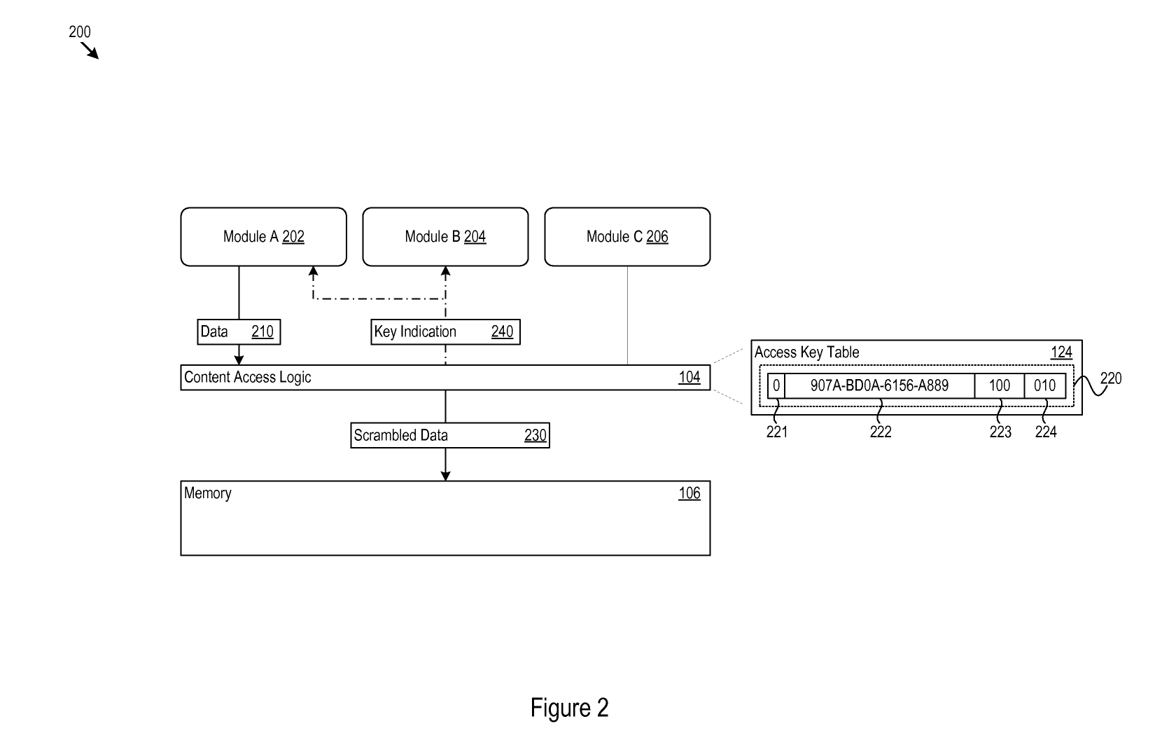

FIG. 2 shows an example of a system 200 that employs content specific data scrambling. The system 200 includes module A 202, module B 204, and module C 206. The modules A 202, B 204, and C 206 are communicatively linked to the content access logic 104. The content access logic 104 controls access to the memory 106, such as when modules of an electronic device 100 read data from and/or write data to the memory 106. FIG. 2, in particular, may illustrate how the content access logic 104 controls access to the memory 106 during a write operation.

The content access logic 104 obtains write data to be stored in the memory 106. For example, the content access logic 104 may receive a memory write request from module A 202. The memory write request may include the write data 210 for storing in the memory 106. The memory write request may also include write parameters, such as a memory address to store the write data 210. In one variation, the write request may specify an access key to be used for storing the write data 210 and/or an indication of the associated access key, such as an access key index.

The content access logic 104 may determine an access restriction associated with the write data 210. An access restriction may specify which modules (e.g., among modules that share use of the memory 106) can and/or cannot access the write data 210. In that regard, the content access logic 104 may determine one or more modules that can read the write data 210 from the memory 106.

The content access logic 104 may determine an access restriction associated with the write data 210 in various ways. Specifically, the content access logic 104 may determine the access restriction associated with the write data 210 based on the content of the write data 210. As one example, the content access logic 104 may determine a data priority associated with the write data 210. A data priority scheme may delineate tiers of modules that can or cannot access the write data 210. As an illustration, the content access logic 104 may characterize the write data 210 as low priority data when the write data 210 can be accessed by each module that shares the memory 106. Low priority data may include, as an example, network data received through a network interface. Intermediate and/or high data priority tiers may correspond to when the write data 210 can be accessed by a predetermined subset of the modules sharing access to the memory 106. The content access logic 104 may identify, for instance, data decrypted by a security module as high priority, whereupon the content access logic 104 may restrict access to the decrypted data to a predetermined subset of the modules that are allowed to access the clear content. Additional examples of high priority data may include clear content, e.g., a decrypted data stream, password data, protected content, banking or financial data, premium A/V content, paid content, data subject to digital rights management (DRM) restrictions, and more. As another example, the content access logic 104 may delineate data according to user and/or application accessibility, such as in a multi-user server. In this example, the content access logic 104 may protect data of a particular user and/or application from other users/applications that can access, for instance, a shared memory of the multi-user server.

The content access logic 104 may enforce a determined access restriction by associating an access key with one or more modules. For instance, the content access logic 104 may maintain the access key table 124 to control access to the memory 106. In FIG. 2, the content access logic 104 determines an access restriction for the write data 210 sent from module A 202. In this particular example, the content access logic 104 determines that module A 202 may insert the write data 210 into the memory and that module B 204 may access, e.g., read, the write data 210 from the memory 106. Accordingly, the content access logic 104 may add the access key entry 220 to the access key table 124 specifying an access key for use to enforce the determined access restriction for the write data 210.

The content access logic 104 may store any number of data fields in an entry of the access key table 124 to identify a particular access key, modules that can use the particular access key, whether the module's use corresponds to a write or read operation, types of data or particular data content associated with the particular access key, or more. In FIG. 2, the access key entry 220 includes four data fields, including an access key index field 221, an access key value field 222, a write access field 223 and a read access field 224. The access key index field 221 may allow a module sending a memory read or write request to specify a particular access key. In that regard, the module may request a particular key without possessing the actual key value itself, which may increase the security and integrity of the access key value and protect the particular access key from being accessed outside the content access logic 104.

The access key value field 222 of an entry may store the value of the access key, which may be operate according to any security, encryption, scrambling, or other data encoding technique. In FIG. 2, the access key table entry 220 stores a 16-byte access key with the value ‘907A BD0A 6156 A889.’ The content access logic 104 may use the access key to scramble, e.g., encode, encrypt, etc., the write data 210 to obtain the scrambled data 230. Then, the content access logic 104 may store the scrambled data 230 in the memory instead of the write data 210. In this way, a module that accesses the memory 106 may be unable to retrieve the write data 210 without having access to the specific access key used to scramble the write data 210.

The write access field 223 may identify particular modules that are authorized to utilize the access key when performing a write operation to the memory 106 and the read access field 224 may identify particular modules that may utilize the access key when performing a read operation to the memory 106. In FIG. 2, the write access field and read access field 224 are implemented as bit maps, which specify respective authorization, e.g., utilization rights, for modules A-B-C in the three bit positions of each field 223 and 224. Consistent with the access restriction determination discussed above, the content access logic configures the access key table entry 220 such that module A 202 is authorized to perform write operations using the access key ‘907A BD0A 6156 A889,’ by writing the value ‘100’ into the write access field 223. In a similar fashion, the content access logic 104 writes the value ‘010’ into the read access field 224 of the access key table entry 220 to specify that module B 204 is authorized to use the access key ‘907A BD0A 6156 A889’ to read data from the memory 106.

When an entry corresponding to a determined access restriction already exists in the access key table 124, the content access logic 104 may forego adding an additional entry corresponding to the determined access restriction. Instead, the content access logic 104 may use the preexisting access key table entry, including by scrambling the write data 210 using the access key of the preexisting entry.

The content access logic 104 may implement any number of alternative or additional data structures to associate a module with an access key and/or store additional data related to the module, access key, or both. For example, the content access logic 104 may implement a module access list that specifies which modules can use a particular access key when accessing the memory 106. As another example, the content access logic 104 may implement an access key list that specifies one or more access keys that a particular module may access.

The content access logic 104 may associate an access key with common set of data. The write data 210 may be part of, for example, an A/V stream decrypted by module A 202 and temporarily stored in the memory 106 during playback or rendering. The content access logic 104 may associate additional or subsequent data of the A/V stream from module A 202 with the same access key. As one implementation, the content access logic 104 may provide a key indication 240 to module A 202 identifying the access key ‘907A BD0A 6156 A889.’ The key indication 240 may specify, for example, the key index of the access key and thereby allow module A 202 to specify that subsequent data from the decrypted A/V stream be scrambled with the access key corresponding to the key index provided by the key indication 240, e.g., with key index ‘0’ as seen in FIG. 2. In that regard, a module sending a write request to the content access logic 104 may include an access key for use when writing the data associated with the write request into the memory 106.

Additionally or alternatively, the content access logic 104 may associate an access key with a common set of data by inspecting the content of subsequent data received from the module A 202. When the content access logic 104 determines a common access restriction as the write data 210, the content access logic 104 may identify access key table entry 220 and scramble the subsequent data accordingly. The content access logic 104 may determine a common access restriction by searching entries in the access key table 124 according to the write access field 223, the read access field 224, or both. As one variation, entries in the access key table may include an additional field identifying data types or content associated with the entry, including the access key of the entry. As examples, the content access logic 104 may associate an access key with data with a common thread ID, utilizing the same DRM key, within the same A/V stream, originating from a common module, application, IP address, or network device, sharing any number of common security, bandwidth, and/or processing requirements, or according to any other data commonalities.

The content access logic 104 may determine that the write data 210 does not have an access restriction, e.g., that the write data 210 may be universally accessed by any module. In this example, the content access logic 104 may scramble the write data 210 using a generally access key, e.g., an access key accessible by any module. In one variation, the content access logic 104 may store the write data 210 without scrambling the write data 210 and forego associating the write data 210 that has no access restrictions with an access key.

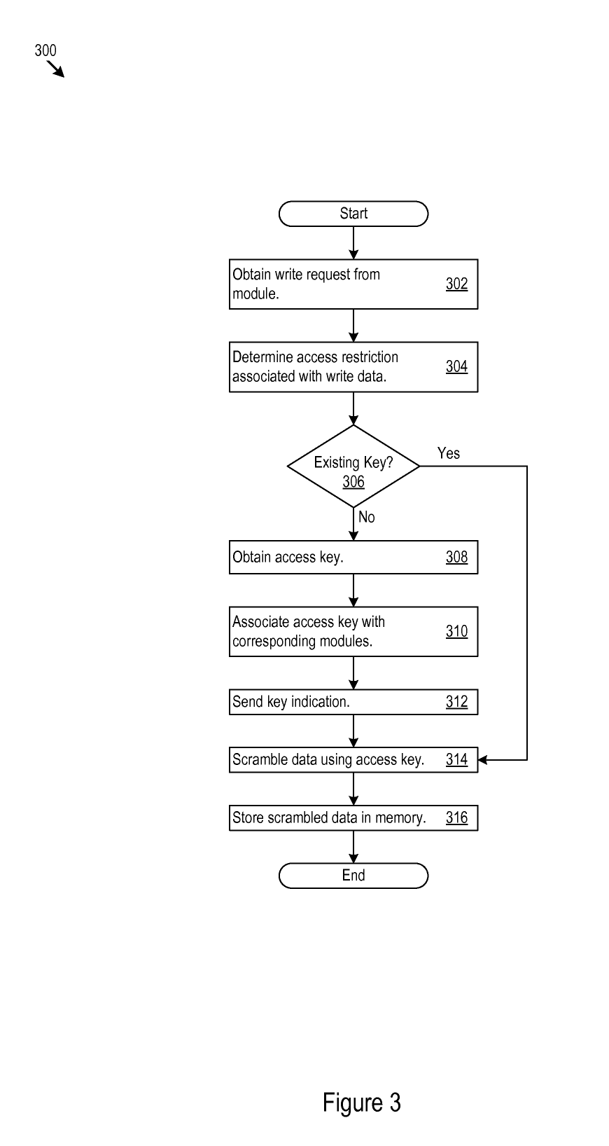

FIG. 3 shows an example of logic 300 that the electronic device 100 may implement as hardware, software, or both. The electronic device 100 may implement the logic 300 as part of the content access logic 104. For example, the content access logic 104 may implement the logic 300 in software as the content access instructions 122.

The content access logic 104 obtains a write request from a module (302), e.g., a processing module in the electronic device 100. The write request may include, for example, write data to be stored in the memory 106 and/or an access key associated with the write data. The content access logic 104 may determine an access restriction associated with the write data (304), including through any of the ways discussed above such as examining the content of the write data, determining a data priority of the write data, and determining which modules are authorized to access the write data.

The content access logic 104 determines whether an access key already exists with respect to the write data (306). In that regard, the content access logic 104 may query the access key table 124 to determine whether an entry is stored for a common data type or data content. The content access logic 104 may additionally or alternatively query the access key table 124 to identify a preexisting access key by searching for a matching write access value, read access value, or both. When the preexisting access key does not exist, the content access logic 104 obtains an access key for the write data (308). As one example, the content access logic 104 may include a security processor and/or security logic operable to generate an access key according to any known scrambling technique, which may include security, encryption, or other data encoding techniques. Exemplary scrambling techniques, including exemplary encryption schemes, include AES, DES, 3DES, proprietary scrambling algorithms, and more.

The content access logic 104 may then associate the obtained access key with one or more modules according to the access restriction (310). For example, the content access logic 104 may insert an entry into the access key table 124 specifying one or more modules that are authorized to use the access key during a write operation (e.g., through a write access bitmap) and/or one or more modules that are authorized to use the access key during a read operation (e.g., through a read access bitmap). The content access logic 104 may send a key indication to the modules authorized to use the access key (312). The content access logic 314, may scramble the write data using the access key (314) to obtain scrambled data and subsequently store the scrambled data in the memory 106 (316).

When the content access logic 104 determines that a pre-existing access key corresponding to the access restriction and/or data content of the write data already exists, the content access logic 104 may use the pre-existing key to scramble the data (314) and store the scrambled data in the memory 106 (316).

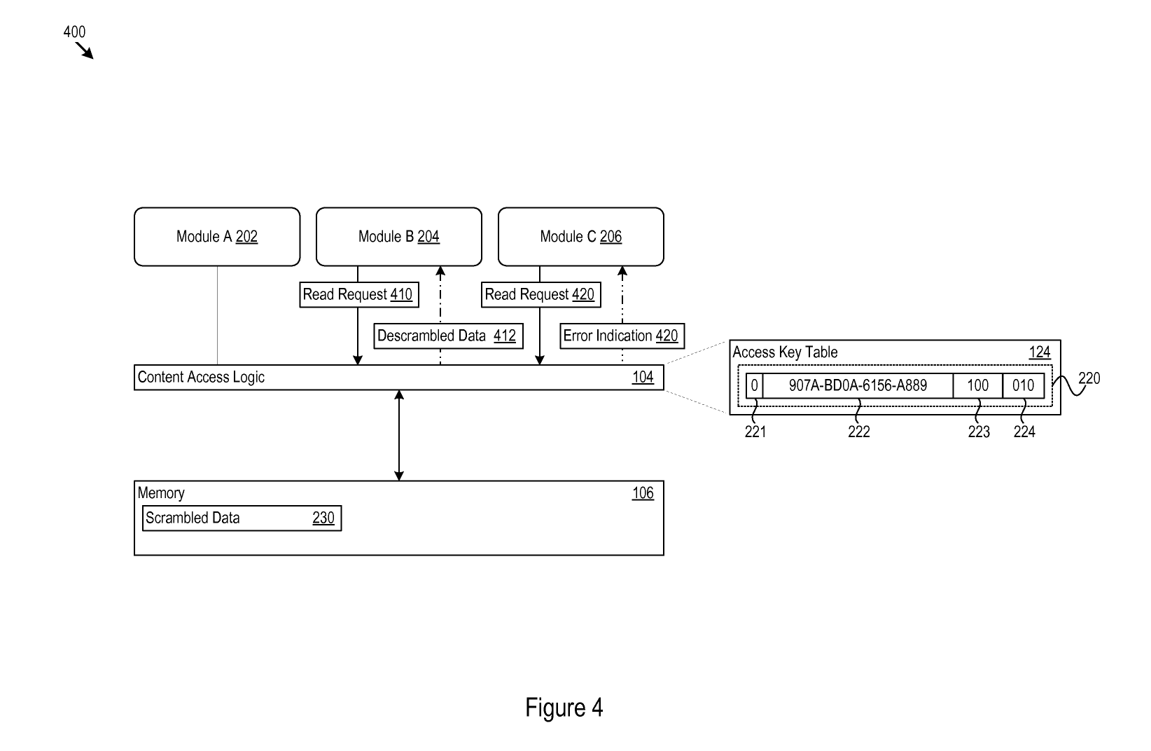

FIG. 4 shows an example of a system 400 that employs content specific data scrambling. In FIG. 4, the memory 106 stores the scrambled data 230 which was scrambled using the access key ‘907A BD0A 6156 A889’ stored in access key table entry 220. The scrambled data 230 corresponds to the write data 210 sent from module A 202 for storing in the memory 106, e.g., as described in FIG. 2.

The content access logic 104 may selectively allow a requesting module to access the scrambled data 230 based on an access key provided by the requesting module. The control access logic 104 may control access to the scrambled data 230 by limiting which modules can request use of the access key used to scramble the scrambled data 230. To illustrate, FIG. 4 shows examples of read requests from module B 204 and from module C 206.

In a first example, module B 204 sends the read request 410 to the content access logic 104. The read request 410 from module B 204 may include a memory access request for the scrambled 230, e.g., by specifying a memory address and/or memory range corresponding to the scrambled data 230. The read request 410 may include an access key indication, identifying an access key the content access logic 104 to use when handling the read request 410. In FIG. 4, the read request 410 includes an access key indication specifying an access key index ‘0.’ In response, the content access logic 104 may perform a lookup in the access key table 124 for the entry corresponding to access key index ‘0.’ As a result of the lookup, the content access logic 104 may retrieve the access key table entry 220, which includes a value of ‘010’ for the read access field 224. The content access logic 104 may determine that module B 204 can utilize the access key in the access key table entry 220 when reading data from the memory 106. Thus, the content access logic 104 may retrieve the scrambled data 230 from the memory 106. The content access logic 104 may descramble the scrambled data 230 using the access key specified in the read request 410, e.g., access key ‘907A BD0A 6156 A889,’ and thus reproducing the write data 210 as the descrambled data 412. The content access logic 104 may then send the descrambled data 412, e.g., the write data 210, to module B 204.

In a second example, module C 206 sends the read request 420 to the content access logic 104, which may similarly include a memory access request to the scrambled data 230. The read request 420 may include an access key indication specifying access key index ‘0.’ Higher layer logic, e.g., a software application (“app”) installed on the electronic device 100, may instruct module C 206 to send the read request 420 specifying access key index ‘0’ even when module C 206 has not previously received a key indication 240 from the content access logic 104 indicating that module C 206 can utilize the access key corresponding to key index ‘0.’ For example, an unauthorized user, e.g., a hacker, may corrupt the higher layer logic and/or requesting module C 206 to send a read request 420 indicating the key index ‘0.’ The content access logic 104 may protect access to the scrambled data 230 by determining that module C 206 is not authorized to utilize the access key stored in the entry 220, as specified by the read access field 224 value of ‘010’ that only authorizes module B 204 to perform reads operations using the access key ‘907A BD0A 6156 A889.’ In response, the content access logic 104 may send an error indication 420 to module C 206, which may take the form of an error message or unusable data, e.g., zero'ed out data. Thus, the content access logic 104 may prevent unauthorized access of the scrambled data 230 by module C 206.

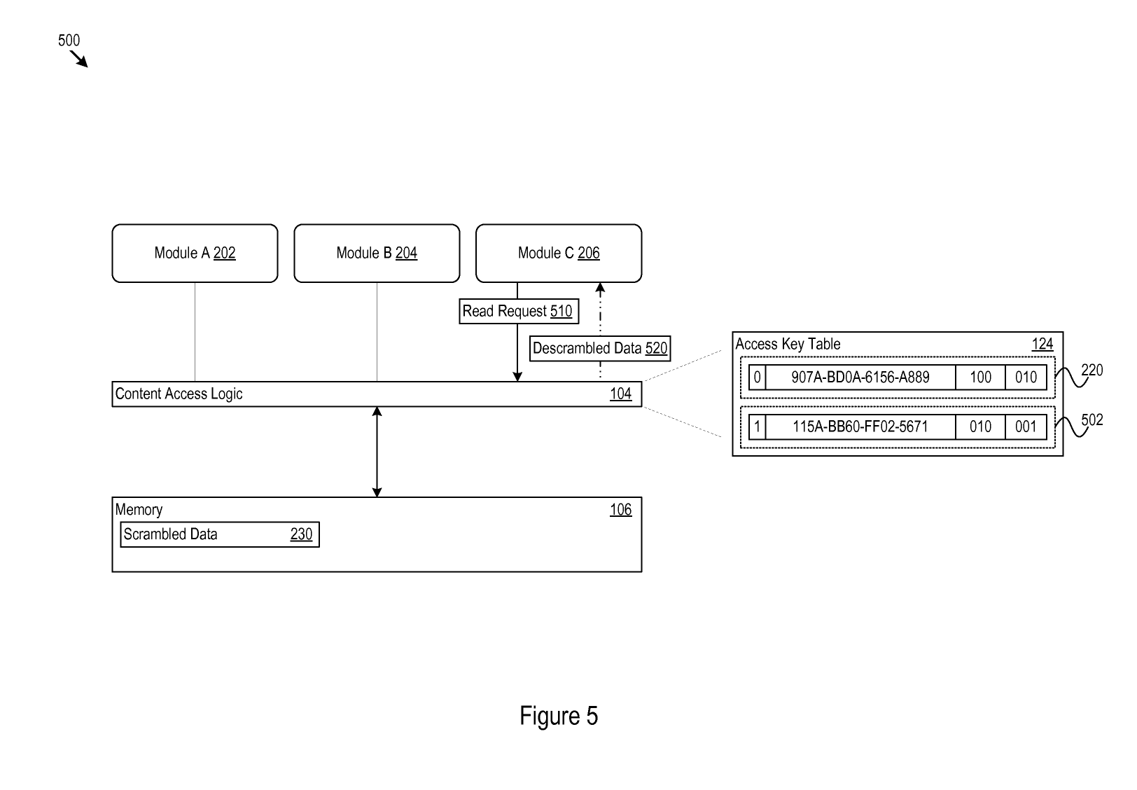

FIG. 5 shows an example of a system 500 that employs content specific data scrambling. In the system 500, the memory 106 stores the scrambled data 230 which was scrambled using the access key ‘907A BD0A 6156 A889’ stored in access key table entry 220. The scrambled data 230 corresponds to the write data 210 sent from module A 202 for storing in the memory 106, e.g., as described in FIG. 2. In FIG. 5, the access key table 124 also includes the access key table entry 502 with an access key index value of ‘1,’ an access key value of ‘1151 BB60 FF02 5671,’ a write access value of ‘010.” The access key table entry 502 further includes a read access value of ‘001’ indicating that module C 206 may perform read operations in the memory 106 using the access key stored in the access key table entry 502, e.g., the access key ‘1151 BB60 FF02 5671.’

The content access logic 104 may control access to the scrambled data 230 by prevent access to the write data 210 when a requesting module is authorized to access the memory 106 using a different access key. To illustrate, the module C 206 sends the write request 510 to the content access logic, specifying a memory address or range corresponding to the scrambled data 230. The write request includes an access key indication specifying key index ‘1,’ which the content access logic 104 determines that module C 206 is authorized to access.

The content access logic 104 may retrieve data from the memory 106 when a requesting module sends a read request identifying a key index that the request module is authorized to access. In FIG. 5, the content access logic 104 retrieves the scrambled data 230 and descrambles the scrambled data 230 using the access key specified by the read request 510, e.g., the access key ‘1151 BB60 FF02 5671.’ In this way, the content access logic 104 obtains the descrambled data 520. However, as the scrambled data 230 was scrambled using the access key corresponding to key index ‘0’ (i.e., ‘907A BD0A 6156 A889’), the content access logic 104 obtains the descrambled data 520 using an incorrect access key. In particular, the descrambled data 520 does not correspond to the write data 210 previously sent by module A 202 and may instead be unusable data. The content access logic 104 sends the descrambled data 520 to module C 206 in response to the read request 510. However, the descrambled data 520 may be unusable to module C 206. In that regard, the control access logic 104 controls access to the scrambled data 230 such that the actual write data 210 can be accessed by authorized requesting modules, e.g., module B 204, and cannot be meaningfully accessed by unauthorized requesting modules, module C 206.

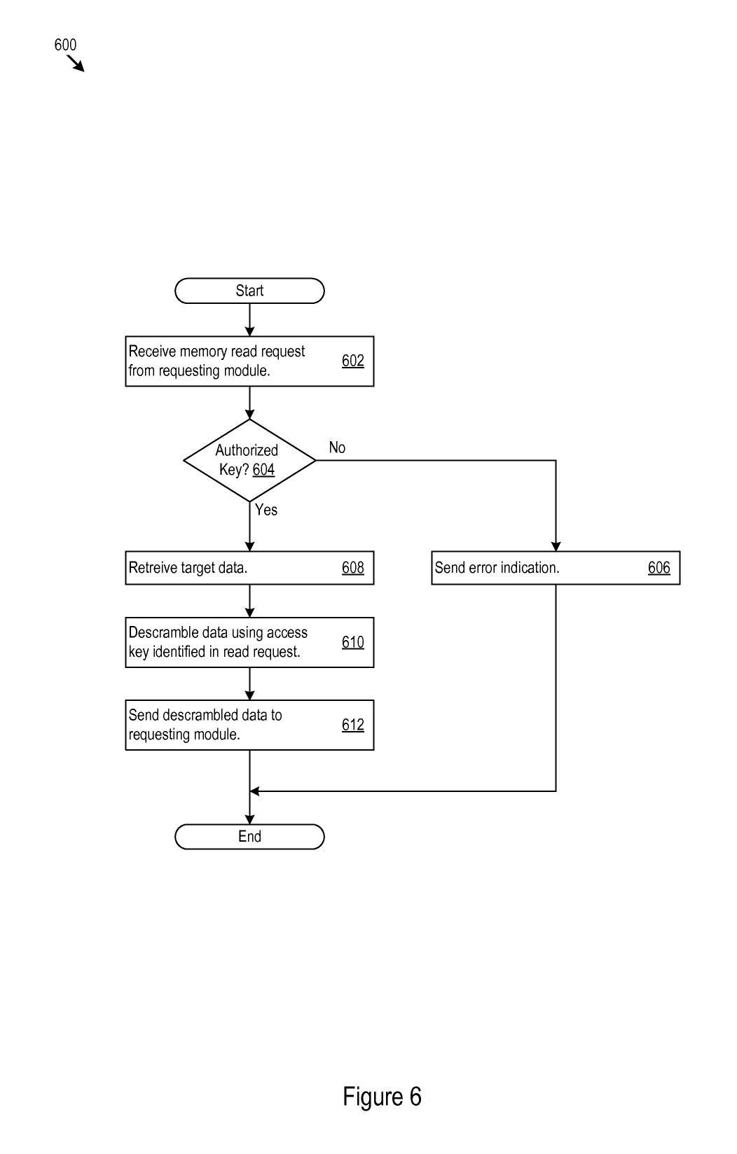

FIG. 6 shows an example of logic 600 that the electronic device 100 may implement as hardware, software, or both. The electronic device 100 may implement the logic 600 as part of the content access logic 104, for example in software as the content access instructions 122. The content access logic 104 receives a memory access request, e.g., a memory read request, from a requesting module (602). The memory read request may specify target data stored in the memory 106 and include an access key indication, such as an access key index.

The content access logic 104 may selectively allow the module to access the target data based on the access key indication, the identity of the requesting module, or both. For example, the content access logic 104 may determine whether the access key indication provided by the requesting module corresponds to an access key that the requesting module is allowed to use when accessing the memory 106 (604). The content access logic 104 may make such a determination by retrieving an entry in the access key table 124 corresponding to the access key indication in the memory read request. The content access logic 104 may determine that the requesting module is not authorized to utilize the access key corresponding to the access key indication when the access key table 124 does not include an entry corresponding to the access key indication or when the entry specifies the requesting module is not authorized to use the corresponding access key of the entry, e.g., as indicated by a read access bitmap. In response to determining access key indication does not correspond to an access key that the requesting module is allowed to use, the content access logic 104 may reject access to the target data. The content access logic 104 may, for instance, send an error indication (606) through an explicit error message or unusable data, e.g., error data.

When the content access logic 104 determines the access key indication provided by the requesting module corresponds to an access key the requesting module is authorized to use, the content access logic 104 may retrieve the target data from the memory 106 (608). The target data may have been previously scrambled using a particular access key. The content access logic 104 may descramble the target data using the access key identified by the access key indication (610). The content access logic 104 may descramble the target data using the access key corresponding to the access key indication of the memory read request. The content access logic 104 may descramble the target data even whether the access key identified by the access key indication is different from the access key previously used to scramble the target data. The content access logic 104 may send the descrambled data to the requesting module (612).

Accordingly, the content access logic 104 may prevent meaningful access to data stored in the memory 106 without dividing the memory 106 into physical or logical partitions. In this way, the content access logic 104 may protect data to be stored in the memory 106 in a content-specific basis and without implementing restrictions in memory locations where data can be stored. The scramble-descramble process described above may itself provide the necessary authentication process to prevent unauthorized access to data, e.g., clear content, that a module requests be stored in the memory 106. The content access logic 104 may achieve this content-specific protection without additional memory overhead and content can be stored at any location in the memory 106.

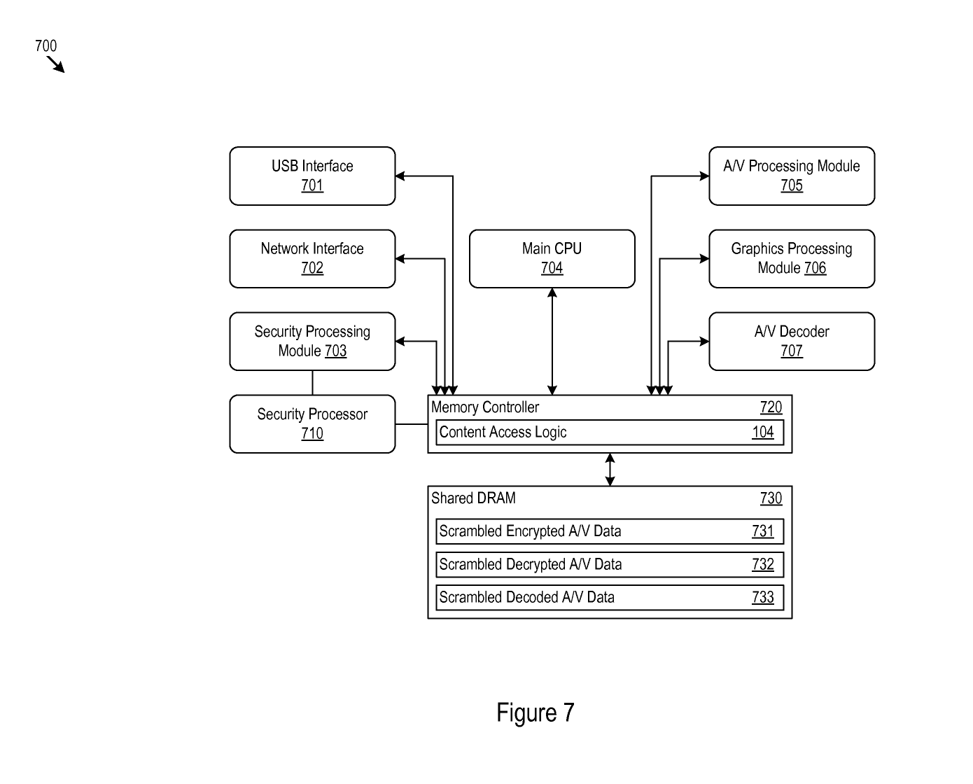

FIG. 7 shows an example of a system 700 that employs content specific data scrambling. The exemplary system 700 includes multiple modules that may be part of a system-on-a-chip. In particular, the system 700 includes a Universal Serial Bus (USB) interface 701, a network interface 702, a security processing module 703, a main CPU 704, an Audio/Video processing module 705, a graphics processing module 706, and an Audio/Video decoder 707. The system 700 may be implemented as part of an Audio/Video rendering device, such as a set-top-box. The system 700 also includes a security processor 710 that may perform any security related functionality in the system 700, e.g., in connection with the security processing module 703. The system 700 also includes a memory controller 720 that interfaces the modules 701-707 to a shared dynamic random access memory (DRAM) 730. In that regard, the memory controller 720 includes content access logic 104.

An illustrative example of data flow in the system 700 that includes content specific data scrambling is presented next. The example relates to presenting an A/V stream.

In this illustrative example, the network interface 702 receives an A/V datastream from across a communication network. The A/V datastream may be provided by, for instance, an online streaming provider or other content provider. The A/V datastream may be encrypted according to a particular encryption scheme employed by the content provider or a digital rights management (DRM) system. The network interface 702 may implement a buffer using the shared DRAM 730 in order to temporarily store the encrypted A/V datastream as modules in the system 700 subsequently process the encrypted A/V datastream. Accordingly, the network interface 702 sends a write request to the memory controller 720 that includes the encrypted A/V datastream. The content access logic 104 may analyze the encrypted A/V datastream and determine an access restriction for the write request from the network interface 702. In this example, the content access logic 104 determines that encrypted A/V datastream is generally accessible to each of the modules 701-707 in the system 700 (e.g., because it is already encrypted) and associates a first access key with the encrypted A/V datastream. Then, the content access logic 104 scrambles the encrypted A/V datastream and stores the scrambled data into the shared DRAM 730 as the scrambled encrypted A/V data 731. Accordingly, the scrambled encrypted A/V data 731 may be twice secured, e.g., first through the encryption performed by the content provider/DRM system and second through the scrambling performed by the content access logic 104. The content access logic 104 may send a key indication to each of the modules 701-707 that specifies using the first access key when accessing the scrambled encrypted A/V data 731 and/or subsequent encrypted A/V data from the same data stream or associated with the same digital rights management (DRM) key or other data commonality.

Continuing the illustrative example, the security processing module 703 may retrieve the scrambled encrypted A/V data 731 in order to decrypt the data for playback. The security processing module 703 may send a memory read request to the memory controller 720 that includes an access key indication identifying the first access key. The content access logic 104 may retrieve and descramble the scrambled encrypted A/V data 731, where the descrambled data is the encrypted A/V stream. The content access logic 104 sends the descrambled data, e.g., the encrypted A/V stream, to the security processing module 703. In the process of decrypting the encrypted A/V datastream, the security processing module 703 may configure a buffer in the shared DRAM 730 to store decrypted A/V datastream as subsequent processing modules render the decrypted A/V datastream for playback. When the security processing module 703 sends a write request to the memory controller 720, the content access logic 104 may determine an access restriction with the decrypted A/V data. In particular, the content access logic 104 may determine that the decrypted A/V data is high priority clear content that can only be accessed by a subsequent processing module in the A/V processing pipeline, e.g., the A/V decoder 707. Accordingly, the content access logic 104 may configure and associate an access key according to the access restriction and scramble the decrypted A/V datastream. Then, the content access logic 104 may store the scrambled decrypted A/V data 732 into the shared DRAM 732, ensuring the scrambled decrypted A/V data 732 is accessible only by the A/V decoder.

In this way, the content access logic 104 may control the access to intermediate, temporary, or buffered data during an A/V broadcast. In a similar fashion, the content access logic 104 may configure and scramble decoded A/V data processed by the A/V decoder such that only the A/V processing module 705 may meaningfully access the scrambled decoded A/V data 733. Accordingly, the content access logic 104 may prevent other modules, such as the USB interface 701 or network interface 702, from accessing the high priority clear content, such as decrypted or decoded A/V datastreams.

In the example above, the content access logic 104 may configure and associate multiple access keys as part of a dataflow. For example, the content access logic 104 may identify the dataflow of the write data to be stored in the shared DRAM 730, such as the encrypted A/V datastream received by the network interface 702. Particularly, the content access logic 104 may determine that the dataflow from the encrypted A/V data stream flows, for example, sequentially from the network interface 702 to the security processing module 703 to the A/V decoder 707 and to the A/V processing module 705. Upon identifying the dataflow, the content access logic 104 may obtain multiple access keys with each access key, each with a access restriction corresponding to a particular point, e.g., data buffer, in the identified dataflow. The content access logic 104 may then send one or more key indications to the respective authorized modules for each access key, e.g., even before a write request is received from the respective module. Thus, the content access logic 104 may perform content specific data scrambling to prevent unauthorized access to data, e.g., clear content.

As described above, the content access logic 104 may support content specific data protection among multiple modules that share access to a memory. The content access logic 104 may determine the write access rights of a module by associating one or more access keys with the module, e.g., a set of write access keys. The content access logic 104 may assign a set or write access keys depending on particular data being stored to the memory and in any of the ways discussed above. The content access logic 104 may determine read access rights of the module by associating one or more access keys with the module, e.g., a set of read access keys. For a module, the content access logic 104 may determine the set of write access keys independently from the set of read access keys. In that regard, the set of write access keys and the set of read access keys for a module may be the same, partially different (e.g., sharing one or more common keys), or completely different.

The methods, devices, systems, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments have been described, it will be apparent to those of ordinary skill in the art that many more embodiments and implementations are possible. Accordingly, the methods, devices, systems, and logic described above are not to be restricted except in light of the attached claims and their equivalents.

What is claimed is:

1. A device comprising:
a memory; and
content access logic in communication with the memory, the content access logic operable to:
obtain first data to be stored in the memory;
identify an access restriction associated with the first data, where the access restriction specifies a module that can access the first data;
obtain an access key for the first data;
provide an access key indication to the module;
obtain scrambled first data by scrambling the first data using the access key; and
store the scrambled first data in the memory.

2. The device of claim 1, where the content access logic is further operable to:
associate the module with the access key.

3. The device of claim 2, where the content access logic is operable to associate the module with the access key by:
adding the access key to an access key table, where the access key table specifies accessible access keys of the module.

4. The device of claim 2, where the content access logic is operable to associate the module with the access key by:
adding the module to an access key table, where the access key table specifies which modules can use the access key when accessing the memory.

5. The device of claim 1, where the content access logic is operable to obtain non-encrypted data as the first data.

6. The device of claim 1, where the content access logic is further operable to:
obtain second data without an access restriction;
obtain scrambled second data by scrambling the second data with a general access key; and
store the scrambled second data in the memory.

7. The device of claim 1, where the content access logic is further operable to:
obtain second data without an access restriction;
store the second data in the memory without scrambling the second data.

8. The device of claim 1, where the content access logic is operable to identify an access restriction associated with first data based on the content of the increased priority data.

9. A device comprising:
a memory; and
content access logic in communication with the memory, the content access logic operable to:
receive a memory access request from a requesting module in the device, where the memory access request specifies target data stored in the memory and includes an access key indication;
selectively allow the module to access the target data based on the requesting module or the access key indication.

10. The device of claim 9, where the content access logic is operable to selectively allow access to the target data by:
determining whether the access key indication corresponds to an access key accessible to the requesting module when accessing the memory; and
rejecting access to the target data by the requesting module when the access key indication does not correspond to an access key that the requesting module is allowed to use.

11. The device of claim 10, where the content access logic is operable to reject access to the target data by the requesting module by:
sending error data to the requesting module.

12. The device of claim 10, where the content access is operable to reject access to the target data by the requesting module by:
sending an error indication to the requesting module.

13. The device of claim 9, where the content access logic is operable to selectively allow access to the target data by:
retrieving the target data from the memory;
obtaining an access key corresponding to the access key indication;
obtaining descrambled target data by descrambling the target data using the access key; and
sending the descrambled target data to the requesting module.

14. The device of claim 13, where the target data retrieved from the memory was previously scrambled using the access key.

15. The device of claim 13, where the target data retrieved from the memory was previously scrambled using another access key different from the access key.

16. A device comprising:
a first module;
a second module;
a memory;
a memory controller in communication with the memory, the memory controller operable to:
configure an access key that is accessible by the first module for a memory write and by the second module for a memory read;
scramble write data using the access key in response to a memory write request from the first module; and
descramble read data retrieved from the memory using the access key in response to a memory read request from the second module.

17. The device of claim 16, where the memory write request from the first module includes an access key indication specifying the access key.

18. The device of claim 16, where the memory read request from the second module includes an access key indication specifying the access key.

19. The device of claim 16, where when the memory read request from the second module includes an access key indication specifying another access key different from the access key, the memory controller is operable to
descramble read data retrieved from the memory using the another access key instead of the access key.

20. The device of claim 16, where the memory controller is further operable to:
configure a set of write access keys accessible by the first module for a memory write;
configure a set of read access keys accessible by the first module for a memory read, where the set of write access keys is different from the set of read access keys.
